(19) United States
(12) Patent Application Publication
(10) Pub. No.: US 2023/0152880 A1
(43) Pub. Date: May 18, 2023

(54) POLICING THE EXTENDED REALITY INTERACTIONS

(71) Applicant: AT&T Intellectual Property I, L.P., Atlanta, GA (US)

(72) Inventor: Joseph Soryal, Glendale, NY (US)

(73) Assignee: AT&T Intellectual Property I, L.P., Atlanta, GA (US)

(21) Appl. No.: 17/527,858

(22) Filed: Nov. 16, 2021

(51) Int. Cl. G06F 3/01

(52) U.S. Cl. CPC G06F 3/011; G06F 3/016; G08B 6/00

(57) ABSTRACT

Aspects of the subject disclosure may include, for example, receiving, over a network, at an extended reality (XR) system, a movement command corresponding to a commanded movement, the commanded movement by a second user at a remote XR system to contact a first user at the XR system, determining if the commanded movement should proceed to contact the user, and responsive to a determination that the commanded movement should not contact the first user, suspending completion of the movement command at the XR system.. Other embodiments are disclosed.

### FIELD OF THE DISCLOSURE

The subject disclosure relates to a monitoring and limiting interactions among participants in virtual reality and extended reality environments.

### BACKGROUND

In virtual reality and extended reality systems, two or more participants interact from remote locations using equipment connected over one or more networks. The interactions may be physical in nature between the participants.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for detecting and controlling potentially aggressive or unpermitted activity in extended reality and highly immersive environments involving a local user and a remote user. In such environments, physical aggression can take place in many forms. In a first example, if the local user is wearing haptic device such as a haptic suit or body overlay, another, remote user can inflict physical harm to the local user wearing the haptic devices. This physical harm can be intentional or unintentional. In a second example, an aggressive remote user can use the hologram controlled by the user, such as the hologram’s body, arm, leg or other virtual body part, to attack the head, the face, or other sensitive body part of the victim, the local user. In a third example, the remote user may be responsible for non-contact violence in which the local user feels threatened and aware of the potential for a serious injury imposed by the remote user. In a fourth example, the remote user may commit unwanted intimate or sexually suggestive actions on the local user. A system in accordance with the subject disclosure operates to detect such aggressive behavior and limit it or prevent it from occurring. Other embodiments are described in the subject disclosure.

One or more aspects of the subject disclosure include receiving, over a network, at an extended reality (XR) system, a movement command corresponding to a commanded movement, the commanded movement by a second user at a remote XR system to contact a first user at the XR system, determining if the commanded movement should proceed to contact the user, and responsive to a determination that the commanded movement should not contact the first user, suspending completion of the movement command at the XR system..

One or more aspects of the subject disclosure include receiving, over a network, a movement command for a first extended reality (XR) system at a first location, the movement command to cause a haptic device of a first user of the first XR system at the first location to contact the first user, the movement command originating at a second XR system of a second user at a second location. One or more aspects of the subject disclosure further include suspending completion of the first movement command by the haptic device, retrieving information about the movement command from a data resource, determining, based on the information about the data resource, if the movement command should cause the haptic device to contact the user and responsive to a determination that the movement command should not cause the haptic device to contact the user, interrupting completion of the movement command at the first XR system.

One or more aspects of the subject disclosure include receiving, over a network, at an extended reality (XR) system, a movement command corresponding to a commanded movement, the commanded movement by a second user at a second XR system at a second location engaging with a hologram at the second location to cause a haptic device to contact a first user of a first XR system at a first location, the first XR system in data communication with the second XR system, determining if the commanded movement will cause the haptic device to contact the first user with a haptic force exceeding a predetermined threshold and responsive to a determination that the commanded movement will cause the haptic device to contact the first user with haptic force exceeding the predetermined threshold, suspending completion of the movement command at the first XR system to prevent an unwanted contact with the first user.

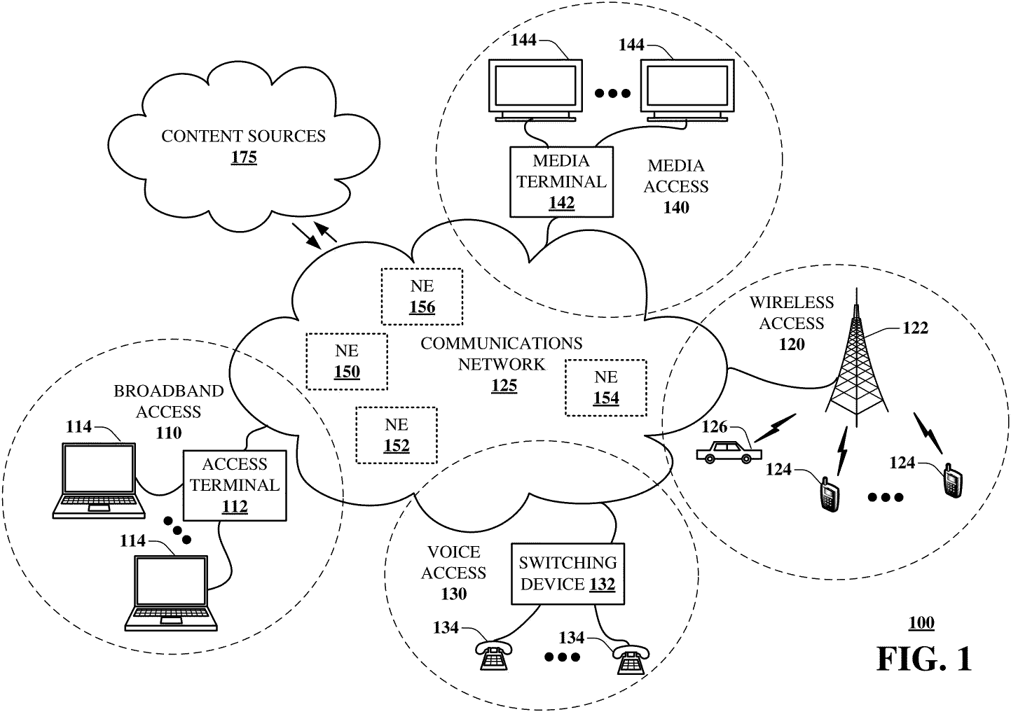

Referring now to FIG. 1, a block diagram is shown illustrating an example, non-limiting embodiment of a system 100 in accordance with various aspects described herein. For example, system 100 can facilitate in whole or in part receiving, over a communication network, at a local extended reality (XR) system information about a commanded movement from a remote XR system and determining of the commanded movement may impart too much force, or may involve unpermitted touching of a user of the local XR system. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or another communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

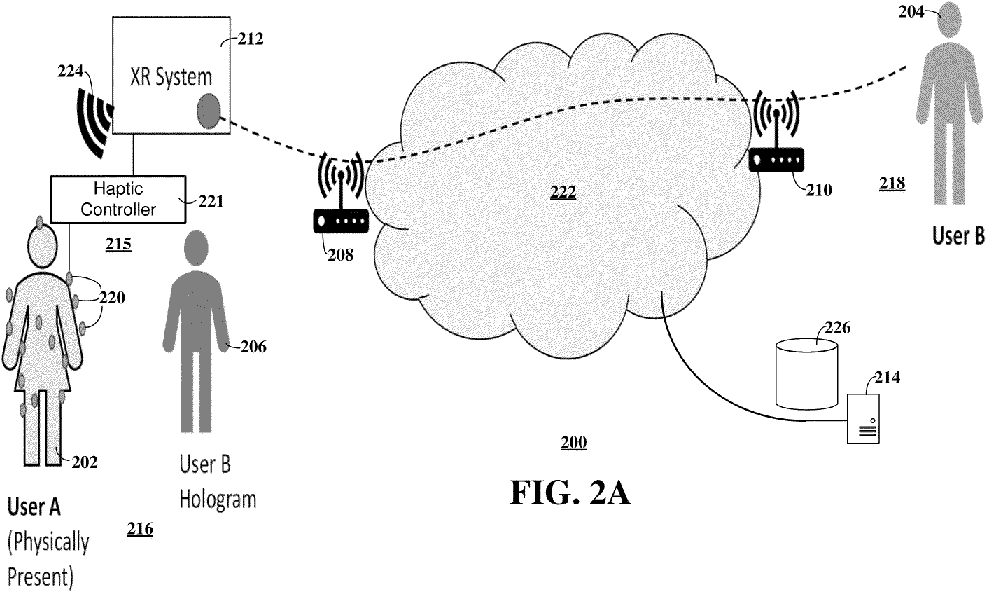

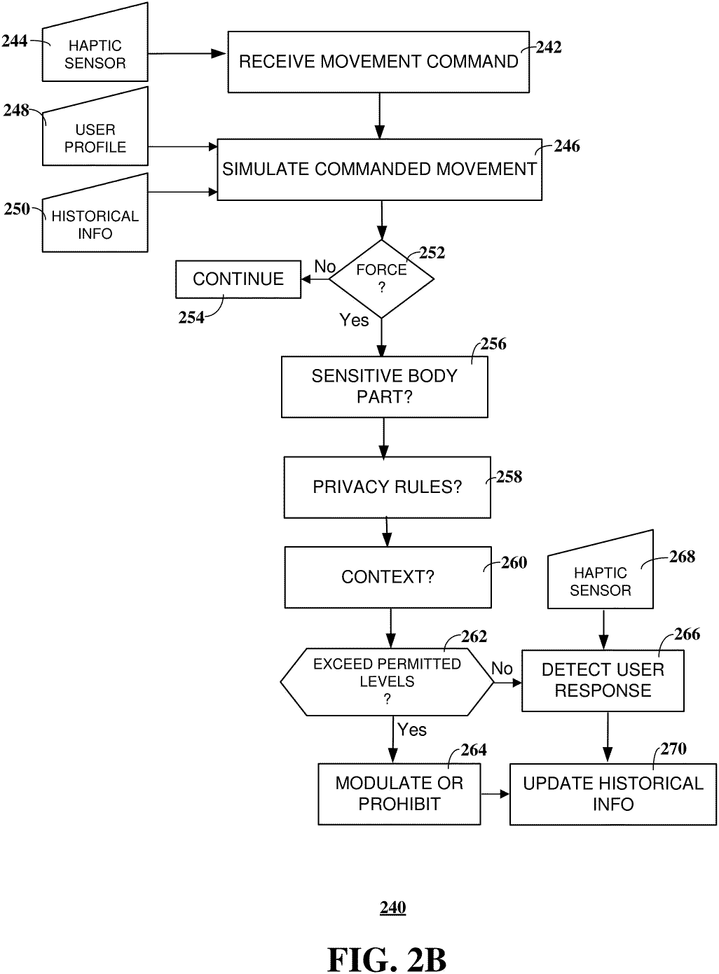

FIG. 2A is a block diagram illustrating an example, non-limiting embodiment of a system 200 functioning within the communication network of FIG. 1 in accordance with various aspects described herein. In some embodiments, portions of the communications network 125, including broadband access 110, wireless access 120, voice access 130, and media access 140 may provide data communication between a first user 202 and a second user 204 participating in the system 200. In the illustrated, exemplary embodiment, the system 200 includes a first extended reality (XR) system 208, a second XR system 210, an XR guard system 212 and an XR guard server 214.

An XR environment may include a combination of real world actions and items and virtual actions and items. The real world environment and virtual environments are combined through data processing technology such as system 200 to produce an XR environment. The first user 202 and the second user 204 may interact with the XR environment using various equipment and techniques to participate in an immersive experience.

Video content is becoming increasingly immersive. Immersive technology allows creation of an immersive experience for a user such as first user 202 and second user 204. An immersive experience includes or presents an environment that is, at least in part, illusory and that seems to partially or completely surround the user so that the user feels to be inside the immersive experience and to be a part of the immersive experience. An immersive environment allows the user to experience some things that are physically impossible. An immersive experience may have the effect of augmenting reality or the real world by combining real world features, or supplementing them or replacing them, with artificially created features. Similar experiences are provided by virtual reality (VR) systems and augmented reality (AR) systems, which are intended to be included in the general term extended reality (XR) systems herein.

In the example of FIG. 2A, the first user 202 is physically present in a first location 216 with a hologram 206. The hologram is a virtual item only and is responsive to control by the second user 204. The second user 204 is located remotely in a second location 218. The second user 204 controls the hologram 206 by means of XR components of the system 200. In some embodiments, the second user 204 may interact with a hologram of the first user 202. The first user 202 interacts with the hologram 206 and thereby with the second user 204.

The first user 202 interacts with a first extended reality (XR) system 208, a second XR system 210, an XR guard system 212 and an XR guard server 212. The first user 202 in this example wears a haptic device such as a haptic suit or haptic body part overlay. The haptic suit may cover substantially all of the body of the first user 202. A haptic body part overlay may cover or engage limited portions of the body of the first user 202, such as the chest, head, arms or hands of the first user 202. An example of a haptic body part overlay is a haptic vest that covers the torso, front and back, of the wearer.

The haptic suit or body part overlay operates as a motion translator. The haptic suit may include features that respond to remote actuation to cause physical, mechanical or electrical stimulation to be felt by the wearer. The actuation may originate very distantly and be conveyed to the wearer and the haptic suit as electrical signals or data over a network or other connection. Moreover, the haptic suit or body part overlay may detect position, movement or other conditions of the wearer or a body part of the and produce corresponding signals that may be conveyed over a network to a remote location to provide information about the wearer.

In the example, the haptic suit or haptic body part overlay incorporates a haptic system 215. The haptic system 215 includes a haptic controller 221 and one or more haptic devices 220. The haptic devices 220 may include a combination of haptic sensors and haptic transducers and haptic actuators. The sensors can operate to capture motions and other activity of the wearer. The haptic transducers and haptic actuators can operate to apply vibration and impact to the wearer. Aspects of the vibration and impact may be controlled by the first XR system 208, such as the force of an impact, the frequency of a vibration, and so on. The haptic controller 221 controls operation of the haptic devices 220 including collecting and processing sensor signals from sensors of the haptic devices 220 and processing and proving control signals to the haptic transducers and haptic actuators of the haptic devices 220. The haptic suit or haptic body part overlay, along with the haptic controller 221, may include other devices to sense conditions of the wearer, such as body temperature, perspiration, respiration and heart rate, and to apply other stimulus to the body of the wearer such as electrical and mechanical stimulation. The haptic suit or haptic body part overlay, along with the haptic controller 221, cooperates with the first XR system 208, the second XR system 210, the XR guard system 212 and the XR guard server 214 to provide an immersive XR experience to the first user 202.

The first XR system 208 is located in the first location 216 with the first user 202 and the hologram 206. The hologram 206 is created and controlled under control of the first XR system 208. The first XR system 208 may include cameras and other sensors to detect information about the first location 216, including location of the first user 202 and activities of the first user 202. The first XR system 208 may include one or more display screens or projectors to create a visual experience for the first user 202.

Further, the first XR system 208 may include or cooperate with an XR headset worn by the first user 202. The XR headset enables the first user 202 to experience, generally, an immersive XR environment. The XR headset generally includes a data processing system including one or more processors, a memory for storing data and instructions, and a communication interface. The XR headset provides visual display to the first user 202 and may include one or more display screens within the XR headset to control the view seen by the first user 202 and the environment experienced by the first user 202. The XR headset generally provides to the first user 202 a panoramic view around the user’s head. Further, the XR headset may include a camera for capturing images of the environment of the first user 202, such as the first location 216. The XR headset may include speakers to provide sound information to the first user 202 and the XR headset may include one or more microphones to collect sound information about the environment of the user 202 at the first location 216. In other embodiments, the XR headset 204 may be embodied as AR glasses or other wearable devices. By means of the XR headset and related visual equipment such as displays, the first user 202 may see the hologram 206 as virtually created and manipulated by the first XR system 208.

The first XR system 208 may be in communication such as radio communication with the haptic suit or haptic body part overlay worn by the first user 202. In particular, the first XR system 208 may be in data communication with the haptic controller 221 and the haptic devices 220. The first XR system 208 may receive data from the haptic controller 221 and one or more haptic sensors of the haptic devices 220, the received data defining a signal indicative of a movement or body position or body condition of the first user 202. Further, the first XR system 208 may provide to the haptic controller 221 data defining an action to be taken by one or more of the haptic transducers and the haptic actuators of the haptic devices 220.

Further, the first XR system 208 is in data communication with the second XR system 210 over a network 222, indicated as a cloud in FIG. 2A. The network 222 may include any combination of networks, including the public internet or communication network 125 of FIG. 1, for data communication among the components of the system 200. Any suitable data communication format may be used. The first XR system 208 and the second XR system 210 may include complementary data communication interfaces to permit communication between the first XR system 208 and the second XR system 210. The first XR system 208 and the second XR system 210 may further include data processing systems such as one or more processors and memory for storing data and instructions to control operation of the processing system. The first XR system 208 and the second XR system 210 may be identical or may include different components or capabilities.

In the example, the second user 204 cooperates with the second XR system 210 which is in the second location 218 with the second user 204. Any suitable user interface may be provided for interaction by the second user 204 with the second XR system. For example, the second user 204 may wear a haptic suit or haptic body part overlay similar to that worn by the first user 202. Some embodiments employ full holographic telepresence in which the system 200 projects realistic, full-motion, substantially real-time three-dimensional images of the users into the space or location of other users. In such an example, the second user 204 may see and interact with a hologram of the first user 202 at the second location 218. Motions and actions of the second user 204 may be sensed by the second XR system 210 and translated to signals suitable to control action and appearance of the hologram 206. Further, motions and actions of the second user 204 may be sensed by the second XR system 210 and translated to signals suitable to control the haptic devices 220 of the haptic suit or haptic body part overlay worn by the first user. In other examples, the second user 204 may interact with a user interface of the second XR system 210 including a keyboard, touch-sensitive display, joystick, XR headset, or any other suitable device. The second user 204 may see the environment of the first location 216 through images originating with cameras of the first XR system 208. Similarly, the second user 204 may hear sounds of the environment of the first location 216 through audio originating with microphones of the first XR system 208. Any other sensors located in the first location 216 may provide information to the second user 204. In some examples, both the first user 202 and the second user 204 experience an immersive XR environment created by equipment of the system 200.

In the example, the second user 204 controls the hologram 206. Further, interactions between the hologram 206 and the first user 202 are under control of the second user 204. For example, the second user 204 may cause the hologram 206 to appear to touch the first user 202. Control operations of the second user 204 are detected by the second XR system 210, such as by communication of signals from a haptic suit worn by the second user 204. The second XR system 210 communicates suitable data to the first XR system 208. The communicated data are received at the first XR system 208 and

Under control of the first XR system 208 and the haptic controller 221, actions of the hologram 206 and the haptic devices 220 are coordinated so that a visual motion of the hologram, perceived through the XR headset worn by the first user 202 or other device visible to the first user 202, matches a physical sensation imparted on the first user by one or more haptic devices 220. Thus, the hologram 206 may appear to reach out and touch the arm of the first user 202, viewed by the first user 202 through the XR headset. Substantially simultaneously, a particular haptic device of the haptic devices 220, under control of the haptic controller 221 and located at approximately the same place on the arm of the first user, will cause a mechanical, physical sensation of touch to the first user 202. For example, a particular haptic device of the haptic devices 220 embodied as a vibrator may cause a touching sensation on the skin of the arm of the first user 202. The first user 202 feels a tap. In another example, the touch may be more forceful, such as a slap on the wrist of the first user 202 or a punch in the arm of the first user 202. In such an example, the visual motion of the hologram 206 may appear more firm or strong or aggressive. Similarly, to match the visual appearance, the mechanical and physical force imposed on the first user 202 may be accentuated. Instead of a vibration by a vibrator of the haptic devices 206 or a light tap by an actuator of the haptic devices 206, a haptic transducer of the haptic devices may apply a stronger force to the wrist or arm. The strength and speed of the force may be adjusted to seem more firm or sharp so that the interaction is felt to a greater degree by the first user 202. The first user 202 feels slapped or punched.

The haptic devices 220 convey force to the wearer of the haptic suit, first user 202, as the force is imposed by the second user 204. The force may be felt proportionately to the imposed force, so that a light tap imposed by the second user 204 is felt as a relatively light force by the first user 202. Proportionately, a hard punch or slap by the second user 204 is felt as a relatively strong or heavy for by the first user 202.

It may occur that the second user 204 will try to be rough with the first user 202. In this case, the second user 204 may try to punch or slap the first user very hard, even trying to do damage to the first user 202. The first user 202 may see the hologram 206 in a motion of punching or slapping the first user 202, in the head or chest, for example. The respective haptic devices of the haptic devices 220 corresponding to where the punch or slap was directed by the second user 204 will actuate under control of the haptic controller 221 and hit the first user 202 in the intended body part. The result can be a severe, painful blow, perhaps enough to cause injury. In another extreme example, the second user 204 may try to choke the first user 202 by means of the system 200, acting through the haptic devices 220. In another extreme example, the second user 204 may attempt some unpermitted touching of the first user, such as touching an intimate body part of the first user 202 or touching in an unwanted sexual manner.

In another extreme example, two persons such as children may be playing together using the system 200. In this example, the second user 204 delivers a heavy punch through the haptic system and the punch is directed at the head or eye or other delicate body part or organ. The heavy punch may be meant playfully but, through automatic operation of the haptics involved could result in a very heavy blow being delivered to the recipient. The intervention of the system 200, including the haptic system 215 that operates somewhat automatically without regard to the condition or sensitivities of the wearer, may cause an injury due to delivery of a blow that is uncontrolled and out of proportion to the users involved. Two children in the same space could not hurt each other to the degree that the intervening system 200 including the haptic devices could. A child who is hit and hurt would cry or run from further blows, which may not be possible where the blows come from the haptic system 215.

In another example, two persons are participating in Esports or electronic sports. Esports are a form of competition using video games, for example. Esports may take the form of organized, multiplayer video game competitions, particularly between professional players, individually or as teams. Typical esports competitions involve multiplayer online battle arena, first-person shooting, fighting, battle royale, and others. Some esports involve haptic devices worn by players to enhance the experience and make the experience more immersive and immediate. However, the presence of haptics controlled automatically or semi-automatically by another player over a network creates a risk of damage or injury to a player. Visual audible or tactile feedback that may cause a competitor to stop or reduce a level of competition, such as an injured player calling for help or holding an injury or falling down, may be absent in the online, esports context.

In another example, a hologram under control of a user such as the second user 204 can become violent. This can result, for example, as a change in mood during a conversation or other interaction, such as during an immersive experience. Some experiences involving XR environments can be so immersive that participants lose track of their situation and forget they are involved in an immersive experience. Such a user can become unmoored and emotional and angry and violent. The local user, first user 202, may have no warning about the change in mood of the second user 204 but may suddenly be subjected to the physical violence of the second user 204, expressed through the system 200 and the associated haptics.

In another example, the second user 204 may be responsible for non-contact violence imparted on the first user 202. In this case, first user feels threatened and is aware of the potential for a serious injury imposed by the remote user. For example, the second user 204 may impart one or more low-level hits or blows on the first user 202, to let the first user 202 know of the damage that could be done by means of the haptic situation. Without escalating to a higher degree of force, the second user 204 may intimidate and threaten the first user 202, who has become aware of the risk of more serious pain or injury.

In another example, a haptic system may be hacked by a third party. If the third party has awareness that the first user 202 is wearing a haptic suit, the third party may gain unauthorized access to network communications with the haptic suit. The third party could intentionally injure the first user 202 using the haptic system or otherwise touch the first user 202 in an unpermitted manner at intimate locations.

An injured first user 202 may have no recourse or defense against a second user 204 who intends to do harm. The second user 204 may be in a second jurisdiction, even overseas, and may be unreachable if the first user 202 is seriously injured. The second user 204 may even be unknown or anonymous across the network 222. The only information available about the second user 204 may be an avatar in the form of the hologram 206 and an online identifier. There is currently no known law regulating such interactions among users.

Thus, in a virtual, extended reality and highly immersive environment, physical aggression can take place between users. If a user is wearing haptic suit or body-part overlay, which allows the users to feel realistic sensations, the other remote user could inflict physical harm to the user wearing the haptic sensors. An aggressive user can push the user’s hologram, including a whole body, an arm, a leg, for example, into the face or other body part of the other user for purposes of intimidation. Further, the aggressive user may make unwanted sexually suggestive moves through the system 200.

There is currently no way to control or limit haptic action received or experienced by a user such as the first user 202 from another user such as second user 204 or even a third party, over a system such as system 200, especially inside of an immersive experience.

In accordance with various aspects described herein the system 200 may further include the XR guard system 212 and an XR guard server 214. The XR guard system 212 forms a local intelligence module. The XR guard system 212 can be embodied in any suitable manner. In some examples, the XR guard system 212 is embodied as a processing system, including a processor and memory, in the location 216 with the first user 202. In some examples, the XR guard system 212 is embodied as an application operating in conjunction with a camera 224 positioned in the location 216 with the first user 202 to observe the first user and collect information about the user. In some examples, the XR guard system 212 is configured as an application operating on a user device of the first user 202 such as a mobile phone, tablet computer or laptop computer of the first user 202. In some examples, the XR guard system 212 is configured as an application operating in the haptic suit or body part overlay itself, in conjunction with the haptic system 215. In general, the XR guard system 212 may reside in any suitable location and be in data communication with other elements of the system 200 such as the first XR system 208 and the haptic devices 220.

The XR guard system 212 operates to detect a commanded movement originating with the second user 204 and intended to create a haptic response on the first user 202. The commanded movement may be any action or movement that will cause a reaction on the body of the first user 202 by the haptic system 215. In an example, the second user 204 throws a punch at a hologram of the first user 202 at the second location 218. The motion and force imparted by the second user 204 is detected by a haptic suit worn by the second user, or by any other suitable device or method. The motion causes generation of signals and data corresponding to the motion and the force imparted. The signals and data are sufficient, when communicated over the network 222 to the haptic system 215 of the first user, to cause the haptic system 215 to impart a force at the body location corresponding to the punch thrown by the second user 204.

The XR system 212 receives the signals and data corresponding to the thrown punch. Before the haptic system 215 responds to the signals and data corresponding to the commanded movement, the XR guard system 212 examines the commanded movement. The XR guard system 212 may signal the first XR system 208 to suspend further processing of the commanded movement. In an embodiment, the XR guard system 212 may analyze and control the commanded movement substantially in real time. In an embodiment, the XR guard system 212 simulates the commanded movement internally to determine the force level that will be imparted on the first user 202 and how this will impact the first user based on preconfigured levels. In an embodiment, the XR guard system 212 retrieves a user profile with information about the first user and uses the user profile information to control or limit the commanded movement.

In some embodiments, the XR guard system 212 examines the signals and data associated with the commanded movement to identify a physical threat posed by the commanded movement. For example, the XR guard system 212 may examine the commanded movement to determine if the commanded movement is directed towards a sensitive organ of the body of the first user 202. Examples of sensitive organs include the eyes and kidneys of the first user 202. Further, the XR guard system 212 may use information such as a personal profile for the first user 202 to determine particular sensitivities of the first user 202. For example, if the first user wears eyeglasses, any movement directed at the head of the first user 202 may be prevented or greatly reduced in force. The XR guard system 212 may have some preset limits or default conditions. For example, if the first user 202 is a child under a certain age such as 15, the XR guard system 212 may prevent any movements to the head of the first user to prevent concussion. The age of the first user 202 may be determined in any suitable fashion, such as from a user profile or from data entered by the first user 202 upon initiation of the XR guard system 212.

To control or limit the commanded movement, the XR guard system 212 may take any suitable action. For example, in some embodiments, the XR guard system 212 will intercept communications from the second XR system 210 to the first XR system 208 to evaluate the communications for any commanded movement. In other embodiments, the XR guard system 212 may intercept only communications from the second XR system 210 to the first XR system 208 that pertain to movements imparting force through the haptic system 215 on the first user. After analyzing an intercepted communication, if the XR guard system 212 determines to limit or control the commanded movement, the XR guard system 212 may modify or update the intercepted communication, including signals and data defining the commanded movement, to adjust the commanded movement according to analysis of the affect of the commanded movement on the first user. Some high-force movements, such as punches or slaps, may be reduced in force or velocity. That is, the XR guard system 212 will substitute for the original communication defining the commanded movement from the second XR system 210 to the first XR system 208 with a substitute communication defining a modified movement. In this example, the modified movement is directed to the same body part of the first user but at a reduced force or velocity.

In some embodiments, the XR guard system 212 examines the signals and data associated with the commanded movement to identify a personal threat posed by the commanded movement. A personal threat may include touching the body of the first user 202 in a sexual manner, or any unpermitted touching of the body of the first user 202. The XR guard system 212 may use any suitable information to determine body parts that are off limits or unpermitted for contact by the haptic system 215. For example, the XR guard system 212 may retrieve a personal profile for the first user 202 to determine body parts the first user 202 has designated as being off limits, such as the hair. In another example, the XR guard system 212 may have certain default conditions for certain users, such as no contact by the haptic system 215 on body areas between the waist and the knees of the first user 202 if the first user 202 is under age 18.

To control or limit the commanded movement, the XR guard system 212 may take any suitable action. For example, the XR guard system 212 may intercept communications intended to control the haptic system 215 and suspend communications that will cause a personal threat to this first user 202. The XR guard system 212 may provide an indication to the first user 202 advising of the personal threat. The XR guard system 212 may further provide an invitation to the first user 202 to override the suspension of the commanded movement that corresponds to a personal threat. Further, the XR guard system 212 may provide an indication to the second user 204, who originated the commanded movement, that the commanded movement corresponds to a personal threat and is not permitted by the system 200. Such indications may be communicated in any suitable fashion, using the network 222, for example.

In some embodiments, the XR guard system 212 can be configured by users for some gaming applications such as physical sports to limit operation of the XR system and the haptic system 115 to a safe impact level so a hit in an e-sport such as an E-Boxing game does not exceed a certain force level. In some embodiments, the particular gaming application may include a feature that allows a global limit on force applied or a global control for all players. The control system may be actuated or not, depending on player preference and selection at a user interface of the gaming application. In other embodiments, each play may select the player’s control and limitation options. Such options the each player may specify include, for various embodiments, a maximum force applied by the haptic system 215, a maximum respective force applied at respective body parts or by respective haptic actuators of the haptic system. In this embodiment, for example, the user may select a relatively light maximum force that can be applied to the head and shoulders, but a relatively heavy force that may be applied to arms and legs. Other embodiments permit defining body parts where touching is not permitted, such as below the waist and above the knees. In embodiments, this may be specified globally for all players participating in the application or may be specified for each respective player.

The XR guard server 214 is also in data communication with other elements of the system 200 such as the first XR system 208, the haptic system 215, the second XR system 210 and the XR guard system 212. The XR guard server 214 in embodiments includes a processing system including a processor and a memory. The XR guard server 214 obtains and stores information about the first user 202, the second user 204, and others involved in the system 200. The XR guard server 214 further stores historical information about respective users and their experiences in the system 200. Such information may be stored by the XR guard server 214 in a database such as database 226. The XR guard server 214 and database 226 may be located in any convenient location and are in data communication with other elements of the network including the first XR system 208, the second XR system 210, and the XR guard system 212. The XR guard server 214 and database 226 may be part of a service or application available to and accessible by users such as first user 202 and second user 204.

In embodiments, the XR guard system 212 and the XR guard server 214 cooperate to identify the individual active as first user 202 and retrieve information about that individual. The retrieved information from the XR guard server 214 is used by the XR guard system 212 to control or limit operation of the haptic system 215 including the haptic devices 220. In an example, the XR guard system 212 has information about the first user 202 and particular aspects of the first user 202. In some embodiments, the first user registers and logs in to a service provided by the XR guard system 212. The XR guard system 212 receives identification information for the user and uses the identification information to learn more about the first user 202. In an embodiment, upon registering with the system or the service, the first user 202 provides information about the first user’s age, physical condition, preferences, interests and other pertinent information.

In embodiments, the first user 202 further specifies how the haptic system 215 should be controlled or limited for the first user 202. For example, the first user 202 may specify an overall maximum force that applies to all haptic touch points of the user’s body. The amount of force can be specified in any suitable manner, using any suitable standard. In another example, the first user 202 may specify a maximum applicable force for each haptic touch point, where each haptic touch point corresponds to a location of a haptic actuator on the haptic suit or body part cover. Similarly, the user may specify maximum force for groups of haptic touch points, such as 3 newtons (N) at the arms and legs and 0.5 N at the head and torso. The user may further define body parts or body areas that may not be touched by the haptic system 215 or that should be off limits. In an embodiment, the user is presented with a graphical user interface on an electronic device such as the user’s mobile phone or tablet computer, or a user interface of the first XR system 208. On the graphical user interface, a profile of a generic human body is shown, with front and rear or other views. The user may use a finger or stylus or other means to engage a touch sensitive display to indicate to the XR guard system 212 what areas of the user’s body are off limits for touching by the haptic system 215. In other embodiments, the user may specify respective areas in this manner but specify what type of haptic interaction is permitted, such as hitting with a specific force, tapping briefly, vibrating in the specified region, etc. The XR guard system 212 receives the user’s input information, which may be communicated over a network including the network 222, and stores the user’s input information in a user profile or other destination. This may be done during registration by the user.

The registration may be used to establish a user profile for the first user 202. The user profile may be stored with other user profiles in the database 226. When the first user 202 subsequently accesses the XR guard system 212, the XR guard system 212 retrieves the user profile from the XR guard server 214 over the network 222. The XR guard system 212 uses the user profile information for the first user 202 to tailor the response of the haptic system 215 to the first user. The XR guard system 212 uses the user profile information for the first user 202 to control or limit the response of the haptic system 215 to inputs from the second user 204.

In an example, the first user 202 is a child. The child logs in to the XR guard system 212 and, based on login information such as the identification for the child, the child’s profile is retrieved from the server 226. The profile may include information indicating the child’s age, specified height and weight, and cannot take more than a specified amount of force from the haptic system 215. The specified amount of force may be defined in any suitable manner, such as a predetermined number of newtons of force.

The profile for the first user 202 may have default values for all users that are overwritten for each respective user based on information about the user, such as age, height, weight, health conditions. Moreover, the profile for each user may be updated each time the user makes use of the XR guard system 212. For example, if the user engages with the system and expresses a feeling that the forces imposed were too great, the user may inform the system and the system will automatically adjust performance in the future. For example, the user profile for the user may be updated with information about the current engagement with the system and the user’s reaction. Updating the user profile may include storing information about forces and locations on the user’s body that were engaged on this usage. Updating the user profile may include updating specific force limits for particular haptic devices 216 of a haptic suit or body part overlay. For example, if the haptic suit is specified by a manufacturer, make and model number having standardized haptic devices 216, the values of forces that may be applied by each standardized haptic device may be specified and updated over time as the XR guard system 212 learns about the individual user.

The XR guard system 212 keeps learning for a specific first user 202 to understand the impact tolerance of the first user 202 by observing the reaction of the first user 202 after delivering an impact initiated by the remote user, second user 204. In an embodiment, one or more cameras of the first XR system 208 observe the location 216 where the first user 202 engages with the hologram 206. Based on images collected by these cameras, the XR guard system 212 estimates the effect on the first user 202 of an impact on the first user 202 by the haptic system 215. The XR guard system 212 may use any suitable apparatus or technique for estimating the effect on the user, such as facial recognition tools to identify a grimace or a smile on the face of the first user after an impact. The force of the impact, measured in newtons, for example, along with other pertinent information such as angle of the impact, velocity of the impact, and others, may be recorded and used to update a user profile for the user. If a particular impact, with its attendant force value and other statistics, causes a first user 202 to grimace in pain, the XR guard system 212 may conclude that that force is too great for this user and, in the future, a lesser force should be applied. The XR guard system 212 is continuously monitoring the impacts of physical contact on the first user 202 and continuously updating information about the first user 202 in the database 226.

In some embodiments, the XR guard system 212 can detect if the first user 202 is a minor and if the second user 204 is improperly interacting with the user wearing haptics. The detection of the first user’s age may be based on the user profile of the first user 202, on data entered by the first user 202 or based on feedback from the haptic system 215, such as the relative size of the first user 202 as the first user 202 puts on the haptic suit. Detection of any improper interaction may be based on particular body areas or body parts that the second user 204 attempts to interact with through the haptic system. In some embodiments, depending on age of the first user 202, the system may block any haptic response by the haptic system 215 that is in unpermitted areas of the body of the first user. The definition of unpermitted areas may be defined universally for all users or may be selectable depending on various factors, such as the age of the first user 202 and the sex of the first user 202. The operation of the XR guard system 212 can be set so it cannot be overridden, in order to protect the first user 202, or the operation of the XR guard system 212 may be overridden in some cases depending on, for example, a relationship of the first user 202 and the second user 204.

The XR guard system 212 may determine the context of the interaction and adjust the behavior of the XR guard system 212 accordingly. For example, if the two users, first user 202 and second user 204, are about the same size and age and have a history of interaction and rough play, the XR guard system 212 may permit higher-force contact between the two based on a conclusion that these two users knows each other and that such rough play is their standard interaction. Initially, the XR guard system 212 may limit the forces applied between the two, each time storing data about their interactions. Over time and after more and more interactions, the XR guard system 212 may evolve its understanding of the two users and reduce the amount of control and limitation placed on the two users.

Another example of context that may be learned for two users relates to a couple who interact physically through the system 200. The couple may be a married couple or otherwise personally involved with each other. In this example, they interact by giving each other massages through the system 200 including the haptic system 215. The XR guard system 212 develops an understanding of the context of their relationship based on their individual interactions and on accumulated history as stored in the database 226. Based on the understanding of context, the XR guard system 212 may reduce limitations on touching in non-permitted areas by the couple.

Another example of context pertains to location information. Each of the first XR system 208 and the second XR system 210 may include a Global Positioning System (GPS) receiver to locate the system or the location where each interaction occurs. The GPS location may be correlated with other information to further determine where one or both users are located at. If the first user 202 is located in a gym, based on GPS location and correlated business address information, the XR guard system 212 uses that location information when deciding how much to limit the forces applied by the haptic system. Activities in a gym may be more energetic and more forceful and may therefore justify a lesser degree of control over the haptic system 215.

Another example of context pertains to physical appearance of one or both users. For example, if the first XR system 208 includes one or more cameras for collecting images of the first user, the first XR system 208 may draw conclusions about health or fitness or capabilities of the first user 202. Based on those conclusions, the XR guard system 212 may modulate or limit the force applied by the haptic system 215. In one example, based on images of the first user 202, the XR guard system 212 may observe a female user with a distended abdomen and conclude that she is pregnant. Based on that context, the XR guard system 212 will limit or prohibit any haptic interaction with the user’s abdomen to prevent any injury.

Another example of context pertains to geographic or cultural variations. In some cultures or some regions, more vigorous or intimate touching may be more acceptable than in other regions or cultures. For example, in some cultures, strangers greet each other with kisses on each cheek. In other cultures, greetings are limited to a handshake. The XR guard system 212 is aware of the location of each user and of cultural norms and will permit physical interactions accordingly. In another example, some cultures permit a friendly pat on the back or on the shoulder. In other cultures, such touching is not acceptable among strangers. The XR guard system 212 stores and retrieves cultural information about each user, including respective locations of the users, to determine the context of the interaction. The forcefulness of touching, or body parts where touching is permitted, may be modulated based on such cultural issues.

The XR guard system 212 communicates with the XR server 214 as a backend server to collect experiences and acceptable impact levels on different bodies and on different users and in different situations. The collected data may be processed by the XR server 214 and stored in the XR database 226. This collective experience gets distributed to the local systems including first XR system 208 and second XR system 210 for enhanced performance regarding detection and prevention or weakening the impact force level for particular experiences or users.

FIG. 2B depicts an illustrative embodiment of a method 240 in accordance with various aspects described herein. Method 240 may be used to analyze a commanded movement in a haptic hologram interaction system. The system may include features similar to features of system 200 (FIG. 2A) and involve interaction between two users. Each user interacts with a hologram in a respective location as part of an extended reality (XR) system. One or both users wear a haptic suit or haptic body part overlay which can sense wearer movement and impart forces to the wearer. The locations and equipment of the XR system including the haptic suits are in data communication. A feature of the XR system monitors interactions between the users in an immersive XR environment and limits or prevents excessive force applied to one user by another or unpermitted touching of one user by another through the haptic suits.

At block 242, method 242 includes receiving a movement command from a user. In an example embodiment, the user wears a haptic suit and interacts with a hologram representing another user. The user moves relative to the hologram as if to touch or strike the hologram. The movement is detected by features of the haptic suit, including a haptic sensor 244. The haptic sensor 244 provides data indicative of the movement of the user and a command is generated to cause the haptic suit worn by the other user to impart a matching touch or force on the other user. In some embodiments, the haptic sensor may be replaced or supplemented with other devices or sensors. In one example, a camera observes the user and movements of the user. Images from the camera are processed to detect the movement and receive the movement command. Sensor and camera inputs may be combined to identify the movement command in block 242.

In block 246, the commanded movement is simulated. Simulating the commanded movement may be performed in any suitable manner. In an example, embodiment, simulating the commanded movement includes identifying a haptic device such as a haptic suit or haptic body part overlay worn by the user and determining a body part of the user to be contacted by the haptic device. Further in this example, simulating the commanded movement may include estimating a force with which the haptic device may contact a body part of the user. The force may be measured in, for example Newtons (N), or any other convenient unit. Further, additional aspects of the haptic for may be simulated, such as an angle of incidence upon the body part of the user or a velocity with which the haptic device may contact the user, etc.

In embodiments, the method 240 may include accessing stored data. The data may be stored in any suitable location, either locally or over a network. In some embodiments, the stored data includes a user profile 248 associated with the user. The user profile may store any suitable information, including information received from the user indicating body part or regions of the body that are off limits or not to be touched by the haptic system, privacy rules defining body parts and permitted and non-permitted types of touching, and information defining how much force is acceptable or permitted by the user. The acceptable amounts of force may be specified for multiple body parts or body regions, or for different circumstances. The information may be obtained or received in any suitable manner, such as by entry of information by the user by means of a user interface on a device, by observing the response of the user to a contact or touching by the haptic system and, in response thereto, establishing or updating an aspect of the user profile such as the privacy rules.

In some other embodiments, the stored data may also or instead include historical information 250. The historical information may be information that is collected automatically and updated automatically by the XR guard system based on past experience with XR systems and users thereof. For example, if the XR guard system detects a force of a particular value directed to a certain body part of a user, the XR guard system may observe and note the reaction of the user to the force. Observation may involve cameras and other optical input to see the user’s response, microphones and other audio inputs to hear the user’s response, and any other suitable types of sensors. If the user’s reaction indicates discomfort or pain, the XR guard system notes this result and stores the result with the historical information 250. Any other information may be stored, such as the age, height, weight, body type and other information about the user, as well as information about the user’s response. The information may be subsequently processed to automatically learn about users and their responses to various forces.

At block 252, the method 240 includes considering the force level to be applied to the body part of the user and how this will impact the user based on preconfigured levels or based on the user profile 2498 or the historical information 250. If the method 240 concludes that the force to be imposed on the body part of the individual is not likely to cause an undue reaction from the user, the method continues at block 254 as the force is applied to the user. Again, though, the user’s response is noted and information about the response is added to the historical information 250 or the user profiled 28, or both.

At block 256, the method 240 determines if the commanded movement to be made by the haptic system will involve a sensitive body part of the individual. Sensitive body parts may be defined by any suitable manner and to include any suitable body part. Examples include the eyes or head, which may be readily damaged by a blow. Further, in some embodiments, sensitive body parts may include intimate body parts or any other body part or region that the user desires to keep private.

At block 258, the method 240 further includes determining if the commanded movement involves any privacy rules established by the user. For example, the user may define boy parts or regions of the body that are off limits and not to be touched, such as intimate body parts. Further, the user may define certain types of unpermitted touching, such as touching with a force exceeding a predetermined threshold or certain types of touching such as tickling or grasping of specified body part of the user. The privacy rules may be stored in any suitable location, such as with the user profile.

At block 260, the method 240 considers the context of the touching or of a force to be applied to a user. For example, if two users are of about similar age and size, the method 240 may conclude that, from this context, the two are friends and may permit a relatively higher degree of force imposed on the user. Similarly, historical information 250 may be retrieved to better define the context of the engagement between the first user and the second user. If the two users have engaged with each other in the past and those engagements involved a relative high degree of contact and force, the method 240 may permit a higher degree of forceful engagement. The context derived at step 260 may incorporate any available information and may operate to increase or decrease a permitted force of engagement or degree of permitted touching.

At block 262, the method 240 determines if the commanded movement exceeds permitted levels. For example, a level of force for a commanded movement simulated at bloc 246 may be compared with a predetermined threshold, such as a permitted level of force specified by a user. The comparison may be for a particular body part or region. In other examples, block 262 may include comparing permitted types or locations of touching with the type and location of touching associated with the commanded movement. For example, if the commanded movement specified tickling of the user’s feet through the haptic suit, but ticking is specifically prohibited by the user’s user profile as determined in privacy rules at block 258 or the feet are considered a sensitive body part in block 256, the commanded movement to tickle feet may be considered to exceed permitted levels at block 262.

If, at block 262, the commanded movement exceeds what is permitted, at block 264, the method 240 includes modulating or prohibiting the commanded movement. For example, if the simulated force exceeds a permitted force at block 262, the method 240 may modulate the force by reducing the force applied by the haptic system to a permitted force level. In another embodiment, the application of the force to the user may be completely prohibited. Similarly, if at block 262, the commanded movement includes a type of touching or location of touching that is prohibited, at block 264, the method 240 may completely prohibit the commanded movement. Further, the method may provide an indication to the first user that the second user attempted to exceed permitted levels and provide an indication or a warning to the second user about attempting to exceed permitted levels.

If the commanded movement did not exceed permitted levels at block 262 and is thus permitted, at block 266 the movement is permitted to occur, and a user response is detected. In an example, the method 240 includes commanding the haptic device 268 to perform the commanded movement and engage with the user. Further, a haptic device 268 may detect the user’s response, such as a cringe of pain, a smile, a shout of pain, etc. At block 270, historical information 250 is updated to note the user’s reaction to the commanded movement. Similarly, at block 264, if the commanded movement was prohibited or blocked, the historical information 250 is updated.

In this manner, the method 240 automatically tracks user responses to forces and touching imposed on the user as well as those that are blocked and updates a historical record. The historical information then may be used by the method in the future. The historical information may be used to determined if this user is comfortable with a commanded movement, or if the commanded movement should be blocked. This historical information may be stored for global access, such as at the database 226 and server 214 for access by other devices controlling XR systems in the illustrated manner. The database 226 collects a wide range of XR interactions and the collected information may be used to control or limit other such interactions.

While for purposes of simplicity of explanation, the respective processes are shown and described as a series of blocks in FIG. 2B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

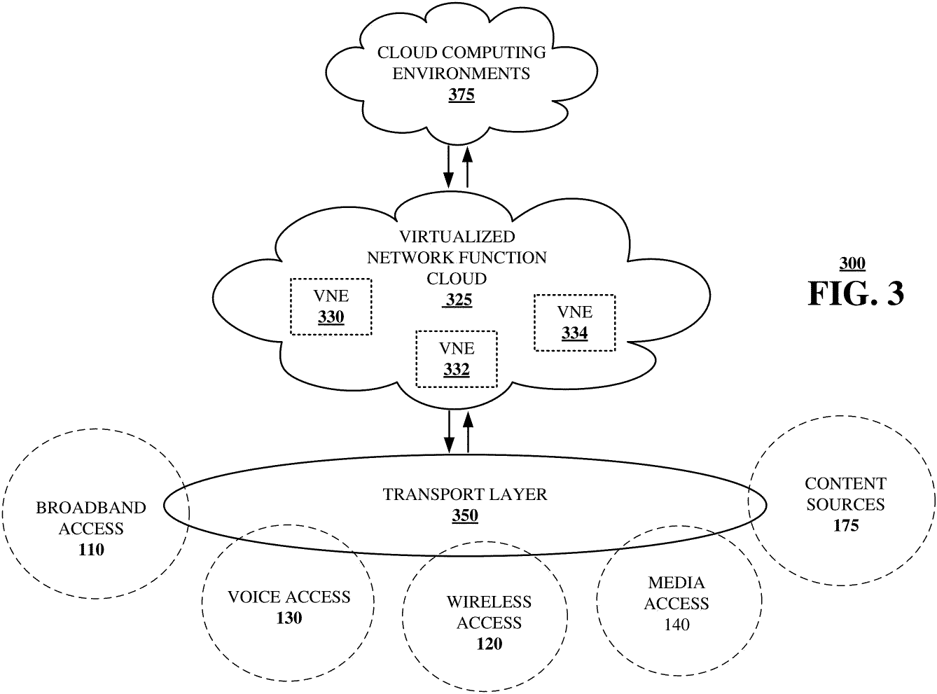

Referring now to FIG. 3, a block diagram is shown illustrating an example, non-limiting embodiment of a virtualized communication network 300 in accordance with various aspects described herein. In particular a virtualized communication network is presented that can be used to implement some or all of the subsystems and functions of system 100, the subsystems and functions of system 200, and method 240 presented in FIGS. 1, 2A, 2B, and 3. For example, virtualized communication network 300 can facilitate in whole or in part receiving over a communication network at a local extended reality (XR) system information about a commanded movement from a remote XR system and determining of the commanded movement may impart too much force, or may involve unpermitted touching of a user of the local XR system.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements - which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it’s elastic: so the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don’t typically need to forward large amounts of traffic, their workload can be distributed across a number of servers - each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third party locations.

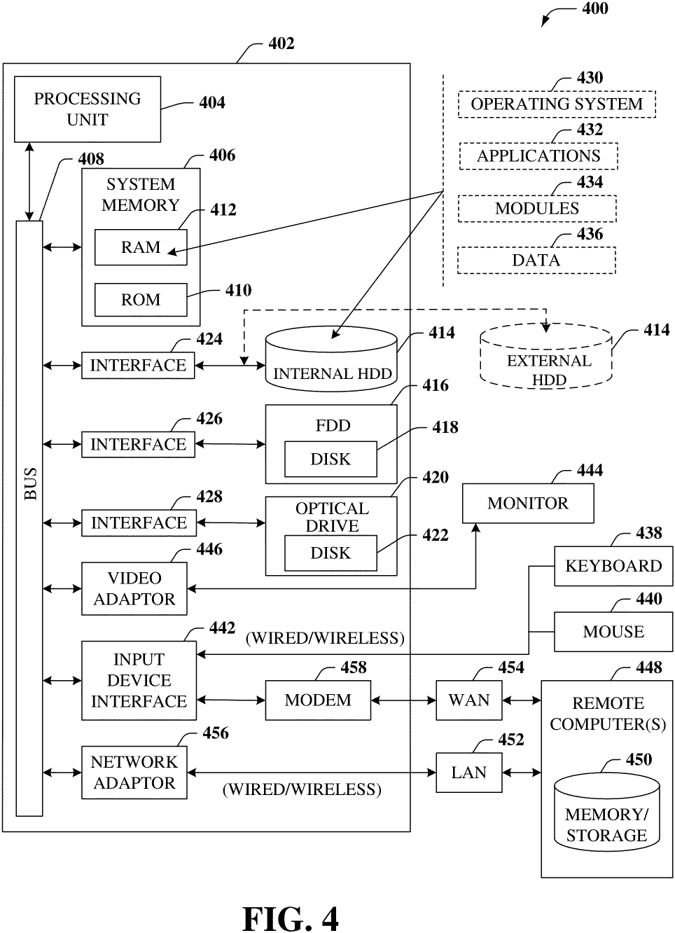

Turning now to FIG. 4, there is illustrated a block diagram of a computing environment 400 in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part receiving over a communication network at a local extended reality (XR) system information about a commanded movement from a remote XR system, and determining of the commanded movement may impart too much force, or may involve unpermitted touching of a user of the local XR system.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM),flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

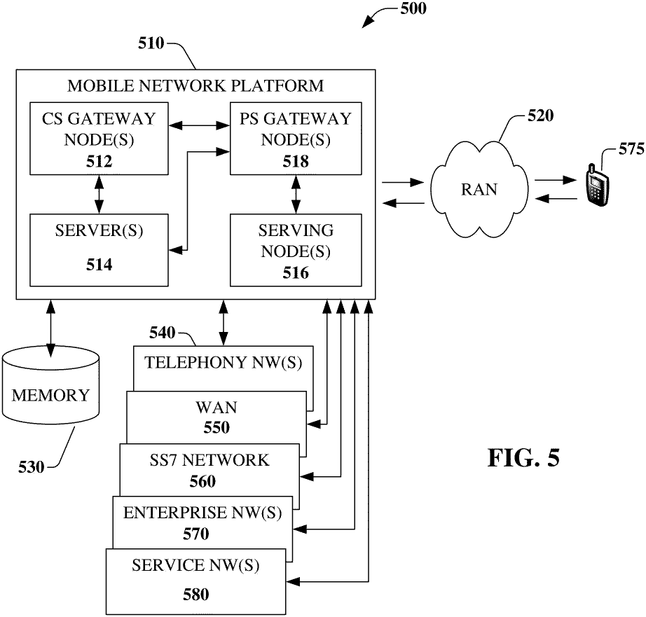

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part receiving over a communication network at a local extended reality (XR) system information about a commanded movement from a remote XR system, and determining of the commanded movement may impart too much force, or may involve unpermitted touching of a user of the local XR system. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technologies utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format ...) such flows. Such application(s) can comprise add-on features to standard services (for example, provisioning, billing, customer support ...) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network’s operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

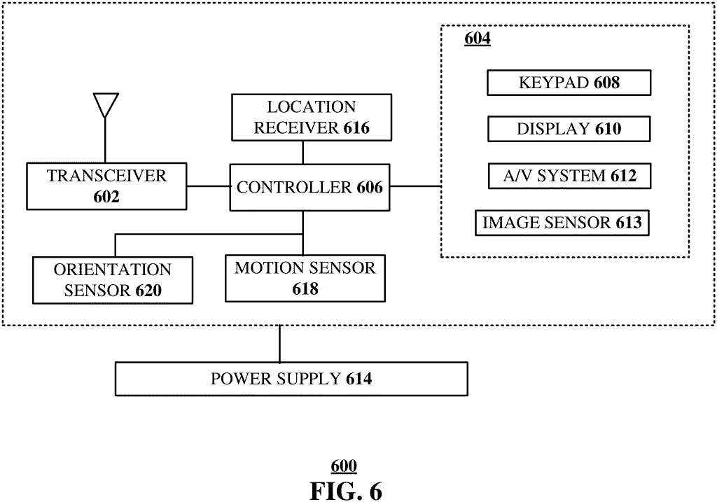

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, communication device 600 can facilitate in whole or in part receiving over a communication network at a local extended reality (XR) system information about a commanded movement from a remote XR system, and determining of the commanded movement may impart too much force, or may involve unpermitted touching of a user of the local XR system.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user’s finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn’t otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x = (x1, x2, x3, x4, ..., xn), to a confidence that the input belongs to a class, that is, f(x) = confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naive Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

1. A non-transitory, machine-readable medium, comprising executable instructions that, when executed by a processing system including a processor, facilitate performance of operations, comprising:
receiving, over a network, at an extended reality (XR) system, a movement command corresponding to a commanded movement, the commanded movement by a second user at a remote XR system to contact a first user at the XR system;
determining if the commanded movement should proceed to contact the first user; and
responsive to a determination that the commanded movement should not contact the first user, suspending completion of the movement command at the XR system;
wherein the determining if the commanded movement should proceed to contact the first user further comprises:
identifying a body part of the first user to be contacted by a haptic device worn by the first user responsive to the commanded movement;
retrieving, for the first user, a user profile associated with the first user;
retrieving, from the user profile, one or more privacy rules of the first user;
comparing the one or more privacy rules with the body part to be contacted by the haptic device; and
suspending completion of the movement command at the XR system responsive to a determination that the body part to be contacted corresponds to a prohibited body part specified by the first user in the one or more privacy rules.

2. The non-transitory, machine-readable medium of claim 1, wherein the determining if the commanded movement should proceed to contact the first user comprises:
determining if a haptic device worn by the first user will impact the first user with a force exceeding a predetermined threshold responsive to the movement command.

3. The non-transitory, machine-readable medium of claim 2, further comprising:
determining the commanded movement should not contact the first user responsive to the determining the haptic device will impact the first user with a force exceeding the predetermined threshold.

4. The non-transitory, machine-readable medium of claim 3, further comprising:
responsive to the determining the haptic device will impact the first user with a force exceeding the predetermined threshold, determining the commanded movement should contact the first user with a predetermined reduced force that is less than the predetermined threshold; and
commanding the haptic device to complete the movement command at the XR system, including commanding the haptic device to complete the movement command with the predetermined reduced force to protect the first user.

5. The non-transitory, machine-readable medium of claim 1, wherein the determining if the commanded movement should proceed to contact the first user comprises:
determining if the commanded movement is directed at a sensitive body part of the first user; and
determining the commanded movement should not contact the first user responsive to the determining the commanded movement is directed at a sensitive body part of the first user.

6. (canceled)

7. The non-transitory, machine-readable medium of claim 1, wherein the determining if the commanded movement should proceed to contact the first user comprises:
identifying a body part of the first user to be contacted by a haptic device worn by the first user responsive to the commanded movement; and
responsive to a determination that the body part to be contacted corresponds to a forbidden intimate body part, suspending the completion of the movement command at the XR system.

8. The non-transitory, machine-readable medium of claim 7, wherein the operations further comprise:
providing a notification to the second user responsive to the determination that the body part to be contacted corresponds to a forbidden intimate body part.

9. The non-transitory, machine-readable medium of claim 7, wherein the operations further comprise:
responsive to the determination that the commanded movement should contact the first user, commanding a haptic device worn by the first user to complete the movement command at the XR system;
observing a response by the first user to the completion of the movement command; and
updating system-level experience data responsive to the response by the first user.

10. The non-transitory, machine-readable medium of claim 9, wherein the determining if the commanded movement should proceed to contact the first user comprises:
retrieving the system-level experience data, responsive to receiving the movement command from the remote XR system;
comparing the movement command with the system-level experience data to determine reactions of other users of other XR systems to command movements corresponding to other movement commands similar to the movement command; and
suspending the completion of the movement command at the XR system responsive to a determination that other users have a negative reaction to being contacted according to the movement command.

11. A device, comprising:
a processing system including a processor; and
a memory that stores executable instructions that, when executed by the processing system, facilitate performance of operations, the operations comprising:
receiving, over a network, a movement command for a first extended reality (XR) system at a first location, the movement command to cause a haptic device of a first user of the first XR system at the first location to contact the first user, the movement command originating at a second XR system of a second user at a second location;
suspending completion of the first movement command by the haptic device;
retrieving information about the movement command from a data resource;
determining, based on the information about the data resource, if the movement command should cause the haptic device to contact the first user;
responsive to a determination that the movement command should not cause the haptic device to contact the first user, interrupting completion of the movement command at the first XR system;
responsive to a determination that the movement command should cause the haptic device to contact the first user, commanding the haptic device worn by the first user to complete the movement command at the first XR system;
observing a response by the first user to contact by the haptic device with the first user; and
updating the system-level experience data based on the response by the first user.

12. The device of claim 11, wherein the retrieving information about the movement command from a data resource comprises:
retrieving a user profile associated with the first user;
retrieving, from the user profile, one or more privacy rules of the first user;
identifying a body part to be contacted by the haptic device responsive to the movement command;
comparing the one or more privacy rules with the body part to be contacted by the haptic device; and
interrupting the completion of the movement command at the first XR system responsive to a determination that the body part to be contacted corresponds to a prohibited body part specified by the first user in the one or more privacy rules of the user profile associated with the first user.

13. The device of claim 11, wherein the retrieving information about the movement command from a data resource comprises:
responsive to receiving the movement command from the second XR system, retrieving system-level experience data, the system-level experience data based on reactions of multiple users on multiple XR systems to multiple movement commands;
comparing the movement command with the system-level experience data to determine reactions of the multiple users of the multiple XR systems to movement commands corresponding to the multiple movement commands similar to the movement command; and
interrupting the completion of the movement command at the XR system responsive to a determination that other users have a negative reaction to being contacted according to the movement command.

14. (canceled)

15. The device of claim 11, wherein the operations further comprise:
identifying a body part of the first user to be contacted by the haptic device worn by the first user responsive to the commanded movement;
responsive to a determination that the body part to be contacted corresponds to a forbidden intimate body part, interrupting the completion of the movement command at the XR system;
providing a notification to the second user responsive to the determination that the body part to be contacted corresponds to a forbidden intimate body part; and
providing a notification to the first user. responsive to the determination that the body part to be contacted corresponds to a forbidden intimate body part.

16. A method, comprising:
receiving, by a processing system including a processor, over a network, at an extended reality (XR) system, a movement command corresponding to a commanded movement, the commanded movement by a second user at a second XR system at a second physical location engaging with a hologram at the second physical location to cause a haptic device to contact a first user of a first XR system at a first physical location, the first XR system in data communication with the second XR system;
determining, by the processing system, if the commanded movement will cause the haptic device to contact the first user with a haptic force exceeding a predetermined threshold; and
responsive to a determination that the commanded movement will cause the haptic device to contact the first user with haptic force exceeding the predetermined threshold, suspending, by the processing system, completion of the movement command at the first XR system to prevent an unwanted contact with the first user.

17. The method of claim 16, comprising:
determining, by the processing system, if the movement command corresponding to the commanded movement causes the haptic device to contact a sensitive body part of the first user; and
suspending, by the processing system, the completion of the movement command at the first XR system to prevent an unwanted contact with the first user responsive to the determining the commanded movement causes the haptic device to contact a sensitive body part of the first user.

18. The method of claim 16, comprising:
identifying, by the processing system, a body part of the first user to be contacted by the haptic device responsive to the commanded movement;
retrieving, by the processing system, a user profile associated with the first user;
retrieving, by the processing system, from the user profile, one or more privacy rules of the first user;
comparing, by the processing system, the one or more privacy rules with the body part to be contacted by the haptic device; and
suspending the completion of the movement command at the first XR system responsive to a determination that the body part to be contacted corresponds to a prohibited body part specified by the first user in the one or more privacy rules.

19. The method of claim 16, comprising:
identifying, by the processing system, a body part of the first user to be contacted by the haptic device responsive to the commanded movement; and
responsive to a determination that the body part to be contacted corresponds to a forbidden intimate body part, suspending, by the processing system, the completion of the movement command at the XR system.

20. The method of claim 16, comprising:
providing, by the processing system, a notification to the second user responsive to the determination that a body part to be contacted by the haptic device corresponds to a forbidden intimate body part; and
providing, by the processing system, a notification to the first user responsive to the determination that the body part to be contacted corresponds to a forbidden intimate body part.

21. The method of claim 16, further comprising:
responsive to a determination that the movement command should cause the haptic device to contact the first user, commanding the haptic device worn by the first user to complete the movement command at the XR system;
observing a response by the first user to contact by the haptic device with the first user; and updating the system-level experience data based on the response by the first user.

22. The method of claim 16, further comprising:
responsive to the determination that the commanded movement will cause the haptic device to contact the first user with haptic force exceeding the predetermined threshold, determining the commanded movement should contact the first user with a predetermined reduced force that is less than the predetermined threshold; and
commanding the haptic device to complete the movement command with the predetermined reduced force to protect the first user, instead of suspending the completion of the movement command at the first XR system.
